(19) United States
(12) Patent Application Publication
(10) Pub. No.: US 2024/0169435 A1
(43) Pub. Date: May 23, 2024

(54) BUDGET APPROVAL WORKFLOW CONFIGURATION SYSTEM AND METHOD

(71) Applicant: Rakuten Symphony Singapore Pte. Ltd., Singapore (SG)

(72) Inventors: Anindita DATTA; Hitomi WAKI, Tokyo (JP); Aman SHEIKH, Madhya Pradesh (IN); Asfak KHAN, Madhya Pradesh (IN)

(21) Appl. No.: 17/756,317

(22) PCT Filed: Apr. 13, 2022
(86) PCT No.: PCT/US2022/024608

§ 371 Date: May 23, 2022

(51) Int. Cl. G06Q 40/06; G06F 3/0481

(52) U.S. Cl. CPC G06Q 40/06; G06F 3/0481

(57) ABSTRACT

A budget approval workflow configuration system (BAWCS) includes a graphical user interface (GUI) to be output by a user interface (UI), the GUI including a first user input field configured to receive a first user input identifying a budget administrator; a second user input field configured to receive a second user input identifying a first reviewer to perform first reviewer responsibilities; a third user input field configured to receive a third user input identifying a workflow action based on a first reviewer approval or rejection of a budget; a fourth user input field configured to receive a fourth user input identifying a workflow location for the budget based on the first reviewer approval or rejection of the budget; and a fifth user input field configured to receive a fifth user input identifying email addresses to provide email notification for a corresponding operation within a budget approval process.

### BACKGROUND

A budget is a financial plan for a defined period. A budget further includes planned sales volumes and revenues, resource quantities, costs and expenses, assets, liabilities, and cash flows. Companies, governments, families, and other organizations use a budget to express strategic plans of activities or events in measurable terms. A budget is the sum of finances allocated for a particular purpose and the summary of intended expenditures along with proposals for how to meet the intended expenditures. A budget surplus includes income exceeding the expenditures, a budget deficit includes expenditures exceeding income, and a balanced budget where the expenditures are substantially equal to the income.

Often, an organization includes multiple departments, each that include multiple project-teams working on separate projects. Typically, a person-in-charge (PIC) of a given department is responsible for managing the workflow of the department, and the PIC of a given project is responsible for managing the workflow of the project.

### BRIEF DESCRIPTION OF THE DRAWINGS

Aspects of the present disclosure are best understood from the following detailed description read with the accompanying figures. In accordance with the standard practice in the industry, various features are not drawn to scale. The dimensions of the various features are arbitrarily increased or reduced for clarity of discussion.

FIG. 1 is a block diagram of a budget approval workflow configuration system (BAWCS), in accordance with some embodiments.

FIG. 2A is a flowchart of a method for budget approval workflow, in accordance with some embodiments.

FIG. 2B is a flowchart of a budget approval workflow method, in accordance with some embodiments.

FIG. 3 depicts a graphical user interface (GUI) for a login page, in accordance with some embodiments.

FIG. 4 depicts a budget approval workflow configuration GUI, in accordance with some embodiments.

FIG. 5 depicts a budget approval workflow configuration GUI, in accordance with some embodiments.

### DETAILED DESCRIPTION

The following disclosure is configured with different embodiments, or examples, for implementing features of the provided subject matter. Examples of components, materials, values, operations, arrangements, or the like, are described below to simplify the present disclosure. These are, of course, examples and are not limiting. Other components, materials, values, operations, arrangements, or the like, are contemplated. For example, the formation of a first feature over or on a second feature in the description that follows includes embodiments in that the first and second features are formed in direct contact and includes embodiments in that additional features are formed between the first and second features, such that the first and second features are unable to be in direct contact. In addition, the present disclosure repeats reference numerals and/or letters in the various examples. This repetition is for the purpose of simplicity and clarity and does not dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

In some embodiments, a budget approval workflow configuration system (BAWCS) is disclosed. In some embodiments, the BAWCS allow users to configure budget approval workflows in a centralized budget management system (CBMS).

In some embodiments, the BAWCS is configured with a user interface (UI) that allows budget administrators to manage budget approval workflow for each type of budget (e.g., department budget, project budget, and other suitable budgets within the contemplated scope of the disclosure) in a systematic and unified manner In some embodiments, the budget administrator configures a level or hierarchy of budget review (e.g., a department head reviews first then a division head, then a corporate head, and so on), that is activated based on a scheduled date (e.g., the budget administrator implements a start date for the approval structure to begin), a status, and a user created in master data. In some embodiments, the BAWCS is configured to send notification emails for each budget approval and rejection.

In other approaches, a company and other organizations have a fixed workflow budgeting system that includes obtaining budget approvals from management (e.g., department heads, division heads, executive officers, CEOs, and other suitable upper management within the contemplated scope of the disclosure) manually. Budget administrators collect budget data from different departments and manage budget approval processes for multiple departments. In a non-limiting example, a financial department PIC collects budget data that is approved by a respective division head and gets approval from upper management (e.g., executive officers, CEO, and other suitable upper management within the contemplated scope of the disclosure) over email.

In other approaches, budgeting systems have an approval flow that is finalized before a fiscal year begins. In the event of structural reorganization or other decisions made by upper management affecting the budget review process, a new manual approval process is implemented by a financial department PIC. New manual approval processes are burdensome for the financial department PIC to track and maintain records. The budget administrators connect with an operations support systems (OSS) team to develop the new approval requirements. This process is time intensive due to collaboration, development, and implementation.

In other approaches, once a fiscal year has begun, the budget is allocated for multiple projects. For each project, the team-project PIC applies for a team-project budget that is approved manually. A department head reviews the applied budgets for each team project. Further, the department head manually balances a finalized department budget against the applied team-project budgets. In other approaches, team-project budgets that have a separate approval process in comparison to the department budget is currently unsupported by budgetary systems. Other approaches are unable to configure two independent approval workflows for each type of or level of budget, such as a team-project budget and a department budget.

In some embodiments, a BAWCS is configured to allow budget administrators to create approval workflows for each type of budget (e.g., team-project vs. department budget). In some embodiments, the BAWCS is configured to allow the budget administrator to add (or change) email addresses for notification emails sent to the budget originator and a user associated with a budget. In some embodiments, in response to any condition, approval event, or rejection event (regardless of whether the email user input field is empty), the reviewer still receives an email notification. In some embodiments, the email input field allows the email notification to be sent to any user, in addition to the reviewer. In some embodiments, the BAWCS is configured to be used by budget administrators in creating approval workflow for each type of budget (e.g., department budget, project budget, or other suitable budgets within the contemplated scope of the disclosure).

In some embodiments, the BAWCS is configured to allow budget administrators to create status details (e.g., status name and color indicator of status shown in the list). In some embodiments, the BAWCS is configured to allow budget administrators to create an approval workflow for each type of budget (e.g., department budget, project budget, or other suitable budgets within the contemplated scope of the disclosure) by defining levels (e.g., hierarchies) of approval. In some embodiments, an effective start date is set at the time of submission of a configured approval workflow (e.g., current budget submission takes effect on January first). In some embodiments, the BAWCS is configured to determine the first budget reviewer based on the activated approval workflow (e.g., approval workflow activated based on effective start date). In some embodiments, once a budget is submitted, the BAWCS sends an email notification to the first reviewer for review and once the budget is approved or rejected, another email is sent to the budget originator (i.e., the person who created the budget application). In some embodiments, budget administrators implement additional email notifications for each incremental level of review. In some embodiments, the BAWCS is configured to retain the budget creator/originator carbon copied (cc'd) in the email (e.g., in a scenario where abc@domain.com creates the budget and after the budget is submitted, the submitted budget is forwarded to first reviewer plus abc@domain.com).

In some embodiments, a submitted budget is mapped (e.g., assigned) with the approval workflow that is currently active for a particular budget. In some embodiments, the BAWCS is configured to allow each budget user to view and track the workflow for each submitted budget through a UI. In some embodiments, BAWCS users view comments entered by each reviewer. In some embodiments, in response to a budget being rejected by a reviewer and resubmitted by the budget creator, the resubmitted budget follows the same approval flow from the beginning (e.g., the first reviewer on up through the hierarchy).

In some embodiments, the BAWCS allows budget administrators to configure approval workflow for each type of budget through a UI, thus reducing development cost for organizational enhancement. In some embodiments, the BAWCS is configured to allow budget administrators to add additional email addresses that receive an informational email based on each approval and rejection of a budget. In some embodiments, the BAWCS is configured to allow a budget administrator to modify an approval workflow, in response to a change in organizational structure.

In some embodiments, the BAWCS is configured with a master data that are configured to be used in the approval workflow, and where the approval workflow configuration is performed by budget administrators. In some embodiments, a budget administrator logs-in to the BAWCS through a terminal (e.g., a UI). In some embodiments, the BAWCS retrieves an applicant's organizational user detail and allows management of budget approval workflow. In some embodiments, the BAWCS allows the budget administrator to create a master status. In some embodiments, the budget administrator configures the approval workflow for each type of budget (e.g., department budget, project budget, or other suitable budgets within the contemplated scope of the disclosure). In some embodiments, the budget administrator selects the organizational user name (e.g., the user responsible as a reviewer), the status on when that action is to be taken (e.g., status on when that selected user is able to review budgets), status of the budget after approval (e.g., the subsequent reviewer the budget transfers to after approval), status after rejection (e.g., where the budget transfers after rejection), and additional email notifications.

In some embodiments, the budget administrator selects a second, third, and up to an Nth number of reviewer (where N is a non-zero positive number). In some embodiments, there is a first reviewer without additional reviewers. In some embodiments, a configured approval workflow is applied with an effective start date. In some embodiments, the BAWCS activates the approval workflow based on the effective start date. In some embodiments, the BAWCS retrieves a current approval workflow for each budget and budget type and obtains all predetermined execution operations in the approval workflow for the submitted budget.

In computing, an execution operation is a unit of task or a unit of work. Alternative terms include process, light-weight process, thread (for execution), operation, request, or query (for work). In a non-limiting example, execution operations perform work from incoming work queues and outputs the completed work. Either the work units themselves or the threads that perform the work are referred to as execution operations, and these are referred to respectively as requests/responses/threads, incoming tasks/completed tasks/threads, or requests/responses/tasks.

In some embodiments, the BAWCS activates a first execution operation at the time of budget submission. In some embodiments, on activation of the first execution operation, the BAWCS processes the submitted budget and updates a status within the status action (e.g., a status that a reviewer has approved or rejected the submitted budget). In some embodiments, the BAWCS grants privileges of budget review activity to selected users (e.g., user who is responsible as a reviewer). In some embodiments, the BAWCS sends an email of a new budget application, along with any additional email notifications predetermined by the budget administrator, to a reviewer.

In some embodiments, the first reviewer approves or rejects the budget. In some embodiments, in the event of budget is approved, status of the budget changes based on the status defined for approval in the first execution operation. Then a next level (e.g., a second execution operation) is automatically activated. In some embodiments, the execution operations are repeated until the final execution operation (e.g., the budget is approved by a final reviewer). In some embodiments, in the event of a budget rejection, the budget status is changed to rejected and the budget is sent back to the first execution operation. In some embodiments, the BAWCS sends an email indicating that the budget application is rejected, along with the reviewer's comments, to the budget originator (e.g., the creator of a submitted budget). In some embodiments, the BAWCS records (e.g., in a log fashion) each action, and each action is reflected in a workflow UI which is viewable by users.

In some embodiments, the budget approval process terminates in response to the final execution operation being activated and approval made by final reviewer. In some embodiments, the BAWCS sends an email of the final-approved budget to the budget originator, while cc'ing one or more of the budget reviewers (e.g., from the first reviewer to the final reviewer).

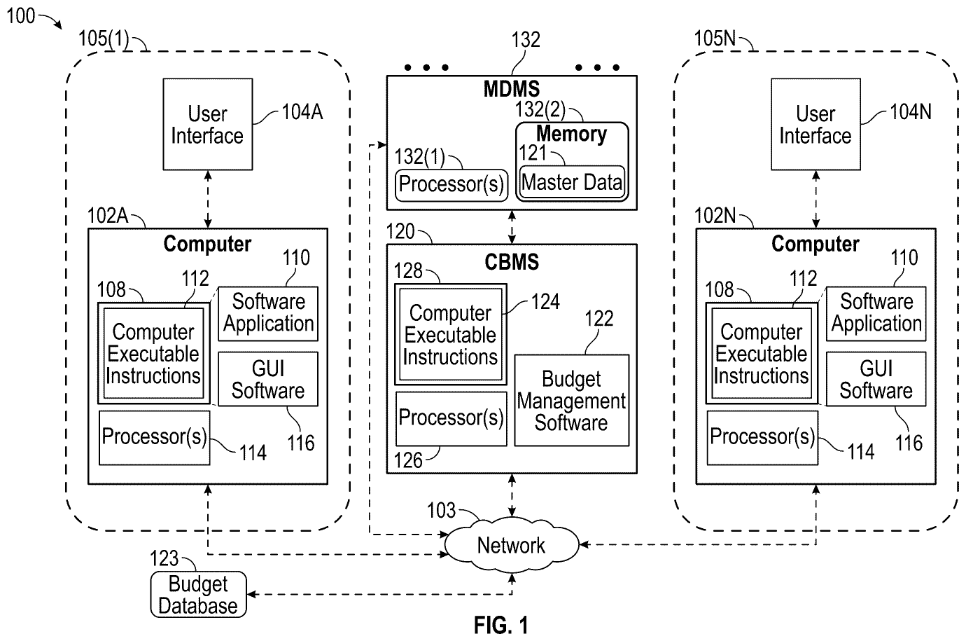

FIG. 1 is a block diagram of a budget approval workflow configuration system (BAWCS) 100, in accordance with some embodiments.

BAWCS 100 includes computers 102A through 102N (where N is a positive non-zero number and computers 102A through 102N are referred to generically or collectively as computers 102) that are operably connected to user interfaces (UIs) 104A through 104N (where N is a positive non-zero number and UIs 104A through 104N are referred to generically or collectively as UI 104). Computers 102 are connected to a centralized budget management system (CBMS) 120 and a master data management system (MDMS) 132 through a network 103. Computers 102 are configured to manage the budget approval workflow (through CBMS 120) for each BAWCS user, and to communicate with MDMS 132 configured to store and retrieve master data 121.

Computers 102 are digital electronic machines that are programmed to carry out sequences of arithmetic or logical operations (computation). Computers 102 perform generic sets of operations known as programs that enable computers 102 to perform a wide range of tasks. In some embodiments, computers 102 are computer systems that include the hardware, operating system (main software), and peripheral equipment. In some embodiments, computers 102 further refer to a group of computers that are linked and function together, such as a computer network or computer cluster.

Computers 102, CBMS 120, and MDMS 132 are communicatively connected to each other via network 103 (e.g., through one or more wireless network interfaces such as BLUETOOTH, WIFI, WIMAX, GPRS, or WCDMA, one or more wired network interfaces such as ETHERNET, USB, or IEEE-884, or a combination thereof).

Computers 102 are communicatively connected (e.g., through a device interface) to respective UI 104 (e.g., terminal). In some embodiments, several computers, hundreds of computers, or thousands of computers are present in BAWCS 100. A UI is one or more input/output (I/O) devices capable of: displaying information communicated from processing circuitry, such as processors 114, to one or more users (e.g., through a GUI, and other suitable display methodologies within the contemplated scope of the disclosure), receiving input (e.g., by using a keyboard, a mouse, and/or other suitable means for receiving input in conjunction with a GUI, and other suitable peripheral device configured to put information into and get information out of a computer within the contemplated scope of the disclosure), and communicating the input to the processing circuitry (e.g., over one or more networks, and other suitable modes used to exchange messages between nodes within the contemplated scope of the disclosure). In various embodiments, UI 104 includes one or more I/O devices located at a single region or distributed over multiple regions (e.g., throughout a global organization, or different locations within a same region, and other suitable structures within the contemplated scope of the disclosure). In some embodiments, the UI is operably responsive to GUI software 116 discussed below. In some embodiments, one or more computers, such as computers 102, are set aside for budget administrators. In some embodiments, the remaining computers, such as computer 102 are configured for budgetary originators and reviewers.

In some embodiments, network 103 includes a wide area network (WAN) (i.e., the internet), a wireless WAN (WWAN) (i.e., a cellular network), a local area network (LAN), a wireless LAN (WLAN), a telecommunication network (e.g., 3G, 4G, LTE, 5G, and other suitable communication platforms are within the contemplated scope of the disclosure), or a combination thereof.

Computer executable instructions 112 are stored on non-transitory computer-readable medium 108 within each of computers 102. In some embodiments, a non-transitory computer readable storage medium (e.g., non-transitory computer-readable medium 108) is an electronic, magnetic, optical, electromagnetic, infrared, and/or a semiconductor read circuit (or apparatus or device). In a non-limiting example, a non-transitory computer readable storage medium includes a semiconductor or solid-state memory, a magnetic tape, a removable computer diskette, a random-access memory (RAM), a read-only memory (ROM), a rigid magnetic disk, and/or an optical disk. In some embodiments using optical disks, a non-transitory computer readable storage medium includes a compact disk-read only memory (CD-ROM), a compact disk-read/write (CD-R/W), and/or a digital video disc (DVD).

In some embodiments, forms of non-transitory computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer reads. The term memory is used herein to refer to a non-transitory computer-readable medium.

Processing circuitry (e.g., one or more processors 114, 126, and 132(1)) include a central processing unit (CPU), a multi-processor, a distributed processing read circuit, an application specific integrated circuit (ASIC), a suitable processing unit, a field programmable gate array (FPGA), or a combination thereof. In some embodiments, the processing circuitry corresponds to one or more processors distributed within a cloud computing environment (e.g., over one or more server clusters).

In some embodiments, GUI software 116 supports forms of human-interface devices that allow users to interact with electronic devices through graphical icons and audio indicator such as primary notation, instead of text-based user interfaces, typed command labels or text navigation. The actions in a GUI are usually performed through direct manipulation of graphical elements.

In FIG. 1, BAWCS 100 includes one or more computers 102, MDMS 132, and CBMS 120. In some embodiments, BAWCS 100 includes up to N computers 102, and more than one CBMS 120. In a non-limiting example, a CBMS is available for each region or a CBMS is available for a set of regions. In some embodiments, CBMS 120 is containerized and distributed in a cluster of servers. These and other configurations for BAWCS 100 are within the scope of this disclosure.

CBMS 120 performs budget data management (e.g., creation, modification, deletion, other suitable management functions within the contemplated scope of the disclosure), and MDMS is configured to be used for master data management (e.g., add, delete, configure, or other suitable operations within embodiments of the present disclosure), in addition to storing master data 121. Computer executable instructions 124 are stored on a non-transitory computer readable medium 128.

CBMS 120 is configured to allow multiple users to create and manage a budget (which include varying types of costs). In some embodiments, CBMS 120 allows multiple users to access, create, and manage the user's budget (e.g., department budget, project budget, or other suitable budgets within the contemplated scope of the disclosure) in a systematic (e.g., presented and formulated as a coherent body of budget ideas and principles) and unified manner (e.g., consistent with other project-team PICs and company employees).

Budget management software 122 is configured to manage the creation, editing, and storing of budget data 123 in budget database 123. In some embodiments, budget database 123 is a building, a dedicated space within a building, or a group of buildings used to house computer systems and associated components, such as telecommunications and storage systems.

To manage the creation, editing, and storing of budget data in budget database 123 and to perform other functions, computers 102 implement various software applications 110 and GUI software 116. Software applications 110 and GUI software 116 are provided as computer executable instructions 112 that are executable by processing circuitry 114 in each of computers 102. Software applications 110 (application or app for short) are computer programs designed to carry out a task other than one relating to the operation of the computer itself, typically to be used by end-users. Budgeting and accounting software is an example.

Budget data within budget database 123 (e.g., department budget data or project budget data discussed below) are database elements including globally applicable, top-level budget data and itemized budget data corresponding to specific items within a given budget. Non-limiting examples of top-level budget data include department or project names or other identifiers, department or project descriptions, budget types or categories, fiscal years, PIC or other usernames, revision indicators, approval status indicators, total amounts, currency identifiers, cost center or other organizational section identifiers, account level identifiers, and other suitable information within the contemplated scope of the disclosure. Non-limiting examples of itemized budget data include time divisions such as months or quarters, location identifiers, measurement identifiers, item identifiers, item descriptions, unit prices, quantities, rental costs, rental durations, labor rates, labor hours, labor descriptions, outsourcing/contract costs, outsourcing/labor descriptions, team or group identifiers, account level indicators, item amounts, sub-total amounts, currencies, currency exchange rates, and other suitable budget information within the contemplated scope of the disclosure.

The database elements of budget data within budget database 123 are controlled by budget management software 122 through processing circuitry 126 as discussed below to have predetermined structures (e.g., data element size, range of values, and other suitable presentations within the contemplated scope of the disclosure) and relationships (e.g., hierarchies, validation links, and other suitable structures within the contemplated scope of the disclosure) whereby budgets created and maintained using CBMS 120 have standardized formatting and operational workflow.

MDMS 132 includes processor(s) 132(1) in communication with memory 132(2) that includes master data 121. MDMS 132 collects data from multiple sources organized for distribution, sharing, and often sub-setting and sharing. In some embodiments, MDMS is a hub and spoke architecture. MDMS is a centralized system to manage master data 121 of different users from different backgrounds. MDMS 132 allows multiple users to access master data 121 while controlling the privilege of the users based on the user's persona. MDMS 132 allows budget admin to create master data 121 in different manners (e.g., via manually inputting information to the UI, or via uploading a document). Such features allow budget admin with different backgrounds to build the master data in a preferred manner, while ensuring the standardization of master data 121. MDMS 132 allows CBMS 120 to compare the parameters inputted by users (when creating budget application) with an allowed budget application (which is defined by master data 121), to reduce the rate of incorrect budget application and reduce the human resources for reviewing incorrect budget application and shorten the overall turnaround time of the budget application.

BAWCS 100 system architecture includes CBMS 120 communicatively connected to MDMS 132. CBMS 120 is communicatively connected to a user interface 104 of a user (e.g., budget originator, budget reviewer, or other suitable budget personnel within the contemplated scope of the disclosure). MDMS 132 is communicatively connected to a UI, such as any of UIs 104 of a budget administrator, and master data 121 and/or budget database 123. In some embodiments, CBMS 120 and MDMS 132 are deployed on one or more cloud servers.

In some embodiments, before a user (e.g., budget originator or reviewer) accesses CBMS 120, master data 121 of a user is created by a budget administrator. In some embodiments, master data 121 is created and managed by a budget administrator. The budget administrator creates master data 121 for users associated to the region assigned to the budget administrator, such as region 105(1) or 105N.

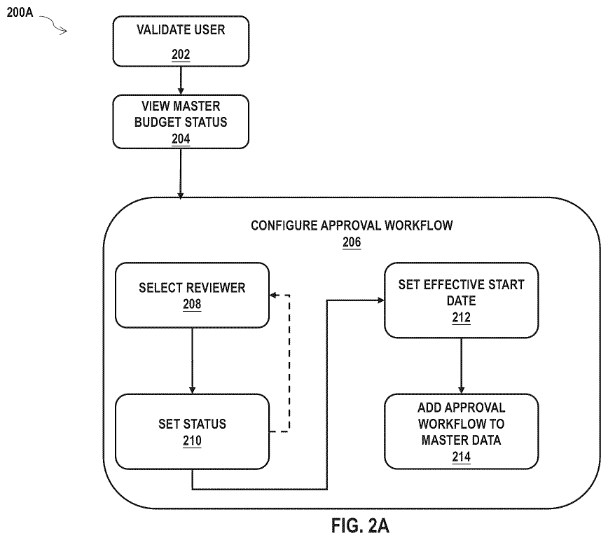

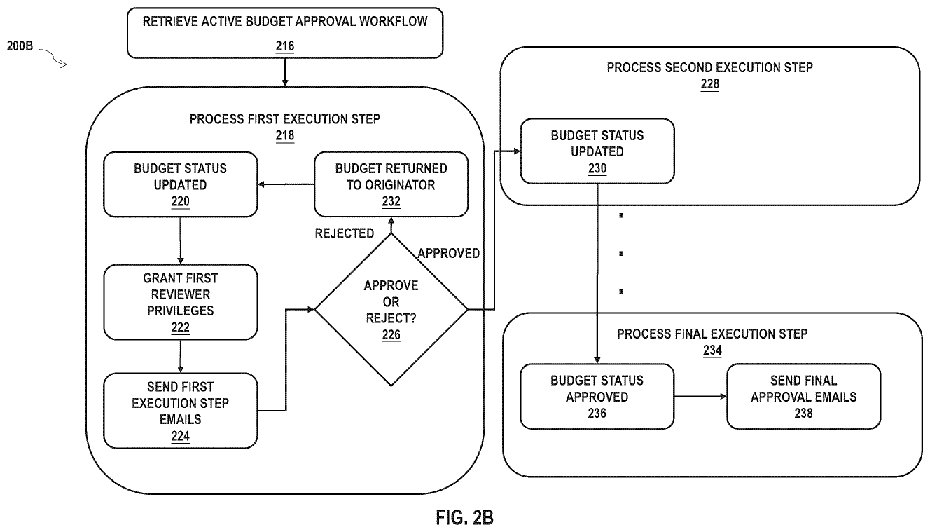

FIG. 2A is a flowchart of a method for configuring budget approval workflow 200A, in accordance with some embodiments.

Method 200A is executed by processing circuitry 126 discussed above with respect to FIG. 1. In some embodiments, method 200A is a method of dynamically managing budget approval workflow from: a UI, an uploaded form, an uploaded template, or other suitable user experience within the contemplated scope of the disclosure. In some embodiments, some, or all the operations of method 200A are executed in accordance with instructions corresponding to budget management software 122 discussed above with respect to FIG. 1.

Method 200A includes operations 202-214, but the operations are not necessarily performed in the order shown. Operations are added, replaced, order changed, and/or eliminated as appropriate, in accordance with the spirit and scope of disclosed embodiments. In some embodiments, one or more of the operations of method 200A are repeated. In some embodiments, unless specifically stated otherwise, the operations of method 200A are performed in order.

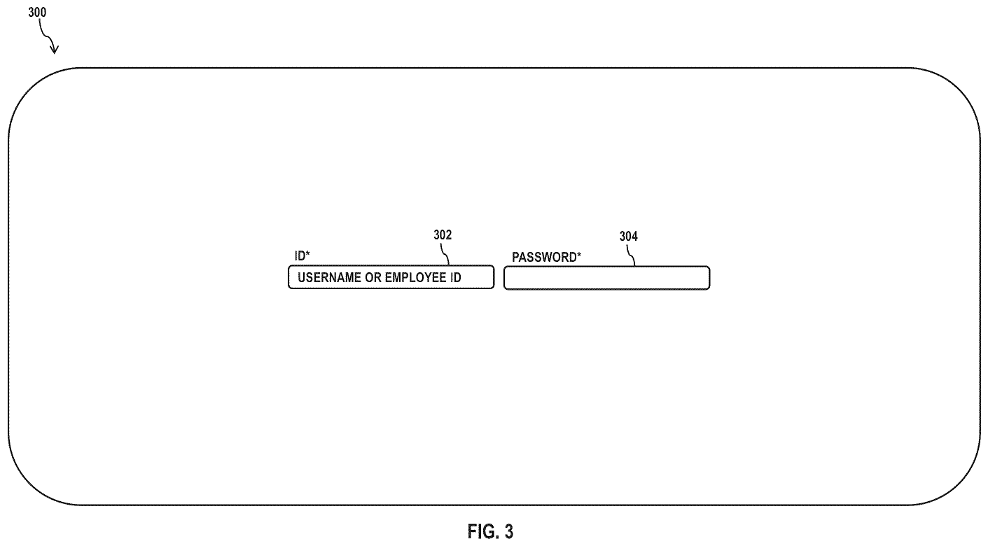

Method 200A is discussed with reference to FIG. 2A and to FIGS. 3-5 that display multiple GUIs in accordance with some embodiments. The discussion of these GUI embodiments are not exhaustive as other suitable GUIs are within the contemplated scope of the disclosure. Further, the appearance of each GUI is generic and one of ordinary skill in the art is able to contemplate other variations. Not all GUIs are necessary to the operation of BAWCS 100 unless specifically stated otherwise. Further, a portion of GUI embodiments are not shown for the sake of brevity and conciseness. However, one of ordinary skill in the art is able to contemplate other GUIs that are configured to be added to a systematic and uniform CBMS, such as BAWCS 100.

FIG. 3 depicts a GUI 300 for a login page, in accordance with some embodiments.

In operation 202 of method 200A, a budget administrator logs into BAWCS 100. In a non-limiting example, at GUI 300 (depicted in FIG. 3) a budget administrator is presented with user input fields 302 and 304. The budget administrator inputs an ID (such as a username, employee ID, or other suitable identification within the contemplated scope of the disclosure) into user input field 302 and a password linked to the budget administrator in user input field 304. In response to BAWCS 100 determining that the input ID and password are accurate, the BAWCS 100 will grant access to the budget administrator.

In FIG. 2A, BAWCS 100 is in electronic communication with master data storage 121 that includes master data associated with each user of BAWCS 100. Master data 121 includes information for each budget administrator. Master data 121 includes information of: the location where the budget administrator works, the budgets that the budget administrator is currently handling and/or has handled in the past, and other suitable information within the contemplated scope of the disclosure.

In response to a budget administrator logging into BAWCS 100 (e.g., by inputting identification (ID) at user input field 302 and a password at user input field 304), BAWCS 100 extracts the budget administrator's master data from master data storage 121, processes master data 121, and allows the budget administrator to manage budget approval workflow. Process flows from operation 202 to operation 204.

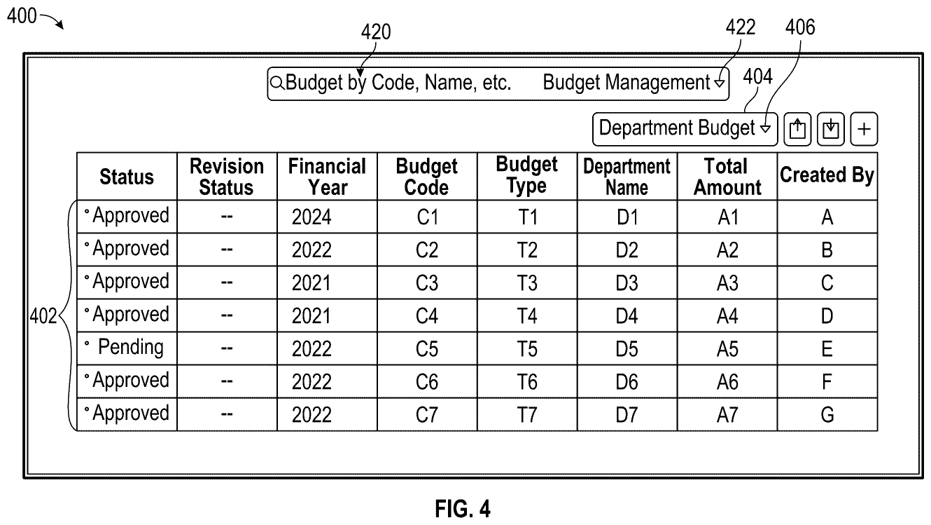

FIG. 4 depicts a budget approval workflow configuration GUI 400, in accordance with some embodiments.

In operation 204 of method 200A, the budget administrator views a master budget status. GUI 400 displays a list of budgets 402. In some embodiments, the budget administrator switches between budgets (e.g., between department budgets, project budgets, or other suitable budgets within embodiments of the present disclosure) in user input box 404 by clicking on down arrow 406 that reveals other budgets to select. In some embodiments, a budget administrator searches for budgets by typing search terms within user input box 420. In some embodiments, the search is assisted by autofill for frequently or previously searched terms. In some embodiments, a budget administrator clicks on the down arrow 422 to reveal prior searched terms to find a budget. Process flows from operation 204 to operation 206.

In operation 206 of method 200A, the budget administrator configures budget approval workflows for each type of budget (e.g., department budget, project budget, etc.) within list of department budgets 402 or a list of project budgets (not shown). Process flows to operation 208.

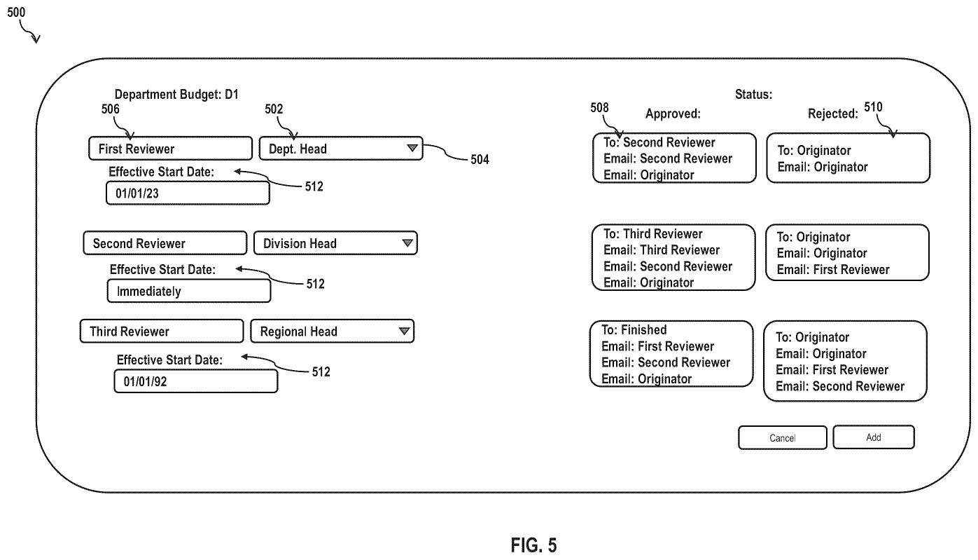

FIG. 5 depicts a budget approval workflow configuration GUI 500, in accordance with some embodiments.

In operation 208 of method 200A, a budget administrator selects a role name 502 of (e.g., department head, division head, etc.) in user input box 504. Process flows from operation 208 to operation 210.

In operation 210 of method 200A, a budget administrator sets an action status. In a non-limiting example, the budget administrator sets the responsibilities (e.g., first reviewer, second reviewer, etc.) the selected role 502 should perform. Continuing with the example, the budget administrator sets a status after approval in user input box 508 (e.g., a status showing the action to be performed on the budget after approval, such as sending the budget to a second reviewer). Continuing with the example, the budget administrator sets a status after rejection in input box 510 (e.g., a status showing the action to be performed on the budget after rejection, such as sending the budget to the budget originator). Continuing with the example, the budget administrator sets, in user input boxes 508 or 510, emails addresses for email notifications based upon budget approval or rejection.

In some embodiments, operations 208 and 210 are iterative and sequentially, in which the budget administrator selects a second, third, and up to Nth reviewer, in a similar manner as described in above. Process flows from operation 210 to operation 212.

In operation 212 of method 200A, a budget administrator sets an approval workflow effective start date. In a non-limiting example, BAWCS 100 activates budget workflow set in GUI 500 based on the effective start date 512. Process flows from operation 212 to operation 214.

In operation 214 of method 200A, in response to the completion of configuration of approval budget workflow, the budget administrator adds the approval budget workflow for the selected budget to master data 121.

FIG. 2B is a flowchart of a budget approval workflow method 200B, in accordance with some embodiments.

Method 200B is executed by processing circuitry 126 discussed above with respect to FIG. 1. In some embodiments, method 200B is executed by processors 114 through an application programming interface (API) that is a connection between budget management software 122. In some embodiments, method 200B is a method of managing budget approval workflow from a UI. In some embodiments, some, or all the operations of method 200B are executed in accordance with instructions corresponding to budget management software 122 discussed above with respect to FIG. 1.

Method 200B includes operations 216-238, but the operations are not necessarily performed in the order shown. Operations are added, replaced, order changed, and/or eliminated as appropriate, in accordance with the spirit and scope of disclosed embodiments. In some embodiments, one or more of the operations of method 200B are repeated. In some embodiments, unless specifically stated otherwise, the operations of method 200B are performed in order.

In operation 216 of method 200B, BAWCS 100 retrieves an active budget approval workflow from master data 121 for each type of budget and retrieves all execution operations predetermined (see method 200A of FIG. 2A) in the active approval workflow to a budget submitted by an originator/creator. Process flow from operation 216 to operation 218.

In operation 218 of method 200B, BAWCS 100 processes a first execution operation at the time of budget submission. In a non-limiting example, a project-team PIC completes and submits a budget. Continuing with the example, on activation of the first execution operation, BAWCS 100 processes the following actions:

In operation 220, the status of the budget (submitted by the budget originator) transfers to the status predetermined in the budget approval workflow. In a non-limiting example, the status of the budget transfers from “creating” to “ready for review”. In another non-limiting example, a status action is taken indicating the submitted budget is ready for review. Process flows from operation 220 to operation 222.

In operation 222 of method 200B, BAWCS 100 grants a first reviewer privileges for reviewing the submitted budget, and thus, providing the first reviewer the privilege of approval and rejection activity. Process flows from operation 222 to operation 224.

In operation 224 of method 200B, BAWCS 100 sends a budget application email (e.g., an email comprises information indicating that a new budget application is submitted) to an email address of the first reviewer as well as to other additional email addresses predetermined in operation 210 of method 200A. Process flows from operation 224 to operation 226.

In operation 226 of method 200B, the first reviewer determines whether to approve or reject the submitted budget. In response to the first reviewer approving the submitted budget (“APPROVED” branch of block 226, status of the submitted budget is again changed at operation 230 as the second level of execution operation is activated at operation 228. Operations 218 and 228 are repeated (e.g., in response to a budget being rejected and sent back to the first reviewer) until a final execution operation indicating a final reviewer approval (e.g., in response to the budget being approved by a final reviewer such as operation 236). While all operations of process second execution operation (operation 228) and process final execution operation (operation 234) are not represented in FIG. 2B with the operations like process first execution operation 218, each of the process execution operations (e.g., the second through the Nth) have similar operation operations to operations 220-226 and 232. In some embodiments, each process execution operation is iterative in processing until reaching the process final execution operation 234.

In response to the first reviewer rejecting the submitted budget (“REJECTED” branch of block 226), the submitted budget transfers back to the budget originator (e.g., the user who created the budget application) in operation 232 of first execution operation 218. BAWCS 100 sends the rejected budget application email (e.g., an email comprises information indicating that the budget application is rejected), along with the comments to the rejection by first reviewer, to budget creator in operation 232. In some embodiments, once the budget originator corrects whatever defect was within the submitted budget (e.g., based upon the comments within the rejection by the first reviewer), process flows to operation 220 from operation 232.

In some embodiments, BAWCS 100 records each action and displays each action to a workflow UI which users (such as the budget originators and reviewers) monitor. In some embodiments, the budget approval process of method 200B ends when a final level of execution operations (operation 234) is activated, and approval is made by final approver (operation 236). Subsequently, at operation 238, BAWCS 100 sends an email of completed budget application (e.g., an email comprises information indicating that the approval process of the budget application is completed) to the budget originator as well as all the reviewers.

In some embodiments, a budget approval workflow configuration system (BAWCS) includes: a memory having non-transitory instructions stored therein; and processing circuitry coupled to the memory, and being configured to execute the non-transitory instructions, thereby causing the processing circuitry to cause a graphical user interface (GUI) to be output by a user interface (UI), the GUI including a first user input field configured to receive a first user input identifying a budget administrator to log in to the BAWCS; in response to a successful log in to the BAWCS, obtain master data from the memory, the master data being associated with the budget administrator; and update the GUI output by the UI, the GUI further including a presentation of each budget associated with the budget administrator; a second user input field configured to receive a second user input identifying a first reviewer to perform first reviewer responsibilities; a third user input field configured to receive a third user input identifying a workflow action based on a first reviewer approval or rejection of a budget; a fourth user input field configured to receive a fourth user input identifying a workflow location for the budget based on the first reviewer approval or rejection of the budget; and a fifth user input field configured to receive a fifth user input identifying email addresses to provide email notification for a corresponding operation within a budget approval process.

In some embodiments, the GUI further includes a sixth user input field configured to receive a sixth user input identifying a sequential reviewer after the first reviewer, wherein the budget administrator inputs up to N reviewers, where N is a non-zero positive integer, that sequentially receive and review the budget after each sequential budget approval beginning with the first reviewer approval.

In some embodiments, the GUI further including a seventh user input field configured to receive a seventh user input identifying an effective start date for assigned reviewer responsibilities.

In some embodiments, the non-transitory instructions further cause the processing circuitry to activate an approval workflow based on the effective start date.

In some embodiments, the non-transitory instructions further cause the processing circuitry to retrieve active approval flow for each budget type; and obtain execution operations in the approval workflow to the budget.

In some embodiments, the non-transitory instructions further cause the processing circuitry to execute a first execution operation based on a first user submitting the budget.

In some embodiments, the non-transitory instructions further cause the processing circuitry to in response to execution of the first execution operation, transfer the budget to the first reviewer; and send a budget application email to the first reviewer and additional emails designated by the budget administrator.

In some embodiments, the non-transitory instructions further cause the processing circuitry to receive the first reviewer approval or rejection.

In some embodiments, the non-transitory instructions further cause the processing circuitry to in response to the first reviewer approval, change a status of the budget to approved in the first execution operation; and execute a next sequential execution operation.

In some embodiments, the non-transitory instructions further cause the processing circuitry to in response to the first reviewer rejection, change a status of the budget to rejected in the first execution operation; and send a rejected budget application email along with comments by the first reviewer to the first user submitting the budget.

In some embodiments, the non-transitory instructions further cause the processing circuitry to record each action; and update the GUI output by the UI, the GUI including an updated budget workflow.

In some embodiments, the non-transitory instructions further cause the processing circuitry to determine whether a final execution operation has been executed and approval made by a final reviewer; and send an email of a completed budget application to the first user submitting the budget and each reviewer of the budget.

In some embodiments, a method executed by processing circuitry includes causing a graphical user interface (GUI) to be output by a user interface (UI), the GUI including a first user input field configured to receive a first user input identifying a budget administrator to log in to a budget approval workflow configuration system (BAWCS); in response to a successful log in to the BAWCS, obtaining master data associated with the budget administrator; and updating the GUI output by the UI, the GUI further including a presentation of each budget associated with the budget administrator; a second user input field configured to receive a second user input identifying a first reviewer to perform first reviewer responsibilities; a third user input field configured to receive a third user input identifying a workflow action based on a first reviewer approval or rejection of a budget; a fourth user input field configured to receive a fourth user input identifying a workflow location for the budget based on the first reviewer approval or rejection of the budget; and a fifth user input field configured to receive a fifth user input identifying email addresses to provide email notification for each operation within a budget approval process.

In some embodiments, the GUI output by the UI further including a sixth user input field configured to receive a sixth user input identifying a sequential reviewer after the first reviewer, wherein the budget administrator inputs up to N reviewers, where N is a non-zero positive integer, that sequentially receive and review the budget after each sequential budget approval beginning with the first reviewer approval.

In some embodiments, the GUI output by the UI further including a seventh user input field configured to receive a seventh user input identifying an effective start date for assigned reviewer responsibilities.

In some embodiments, a non-transitory computer readable medium including instructions executable by a controller to perform operations including causing a graphical user interface (GUI) to be output by a user interface (UI), the GUI including a first user input field configured to receive a first user input identifying a budget administrator to log in to a budget approval workflow configuration system (BAWCS); in response to a successful log in to the BAWCS, obtaining master data associated with the budget administrator; and updating the GUI output by the UI, the GUI further including a presentation of each budget associated with the budget administrator; a second user input field configured to receive a second user input identifying a first reviewer to perform first reviewer responsibilities; a third user input field configured to receive a third user input identifying a workflow action based on a first reviewer approval or rejection of a budget; a fourth user input field configured to receive a fourth user input identifying a workflow location for the budget based on the first reviewer approval or rejection of the budget; and a fifth user input field configured to receive a fifth user input identifying email addresses to provide email notification for each operation within a budget approval process.

In some embodiments, the GUI output by the UI further includes a sixth user input field configured to receive a sixth user input identifying a sequential reviewer after the first reviewer, wherein the budget administrator inputs up to N reviewers, where N is a non-zero positive integer, that sequentially receive and review the budget after each sequential budget approval beginning with the first reviewer approval.

In some embodiments, the GUI output by the UI further includes a seventh user input field configured to receive a seventh user input identifying an effective start date for assigned reviewer responsibilities.

In some embodiments, the instructions executable by a controller further performs operations including activating an approval workflow based on the effective start date.

In some embodiments, instructions executable by a controller further performs operations including retrieving active approval flow for each budget type; and obtaining execution operations in the approval workflow to the budget.

The foregoing outlines features of several embodiments so that those skilled in the art are able to better understand the aspects of the present disclosure. Appreciation by those skilled in the art that the present disclosure is a basis for designing or modifying other processes and structures for carrying out the same purposes and/or achieving the same advantages of the embodiments introduced herein is contemplated. Those skilled in the art further realize that such equivalent constructions do not depart from the spirit and scope of the present disclosure, and to make various changes, substitutions, and alterations herein without departing from the spirit and scope of the present disclosure is contemplated.

What is claimed is:

1. A budget approval workflow configuration system (BAWCS), comprising:
a memory having non-transitory instructions stored therein; and
processing circuitry coupled to the memory, and being configured to execute the non-transitory instructions, thereby causing the processing circuitry to:
cause a graphical user interface (GUI) to be output by a user interface (UI), the GUI comprising:
a first user input field configured to receive a first user input identifying a budget administrator to log in to the BAWCS;
in response to a successful log in to the BAWCS, obtain master data from the memory, the master data being associated with the budget administrator; and
update the GUI output by the UI, the updated GUI comprising:
a presentation of a budget associated with the budget administrator;
a second user input field configured to receive a second user input identifying a first reviewer to perform first reviewer responsibilities;
a third user input field configured to receive a third user input identifying a workflow action based on a first reviewer approval or rejection of a budget;
a fourth user input field configured to receive a fourth user input identifying a workflow location for the budget based on the first reviewer approval or rejection of the budget; and
a fifth user input field configured to receive a fifth user input identifying email addresses to provide email notification for a corresponding operation within a budget approval process.

2. The BAWCS of claim 1, wherein the GUI further comprising:
a sixth user input field configured to receive a sixth user input identifying a sequential reviewer after the first reviewer, wherein the budget administrator inputs up to N reviewers, where N is a non-zero positive integer, that sequentially receive and review the budget after each sequential budget approval beginning with the first reviewer approval.

3. The BAWCS of claim 2, wherein the GUI further comprising:
a seventh user input field configured to receive a seventh user input identifying an effective start date for assigned reviewer responsibilities.

4. The BAWCS of claim 3, wherein the non-transitory instructions further cause the processing circuitry to:
activate an approval workflow based on the effective start date.

5. The BAWCS of claim 4, wherein the non-transitory instructions further cause the processing circuitry to:
retrieve active approval flow for each budget type; and
obtain execution operations in the approval workflow to the budget.

6. The BAWCS of claim 5, wherein the non-transitory instructions further cause the processing circuitry to:
execute a first execution operation based on a first user submitting the budget.

7. The BAWCS of claim 6, wherein the non-transitory instructions further cause the processing circuitry to:
in response to execution of the first execution operation, transfer the budget to the first reviewer; and
send a budget application email to the first reviewer and additional emails designated by the budget administrator.

8. The BAWCS of claim 7, wherein the non-transitory instructions further cause the processing circuitry to:
receive the first reviewer approval or rejection.

9. The BAWCS of claim 8, wherein the non-transitory instructions further cause the processing circuitry to:
in response to the first reviewer approval, change a status of the budget to approved in the first execution operation; and
execute a next sequential execution operation.

10. The BAWCS of claim 8, wherein the non-transitory instructions further cause the processing circuitry to:
in response to the first reviewer rejection, change a status of the budget to rejected in the first execution operation; and
send a rejected budget application email along with comments by the first reviewer to the first user submitting the budget.

11. The BAWCS of claim 10, wherein the non-transitory instructions further cause the processing circuitry to:
record each action; and
update the GUI output by the UI, the GUI comprising:
an updated budget workflow.

12. The BAWCS of claim 11, wherein the non-transitory instructions further cause the processing circuitry to:
determine whether a final execution operation has been executed and approval made by a final reviewer; and
send an email of a completed budget application to the first user submitting the budget and each reviewer of the budget.

13. A method executed by processing circuitry, the method comprising:
causing a graphical user interface (GUI) to be output by a user interface (UI), the GUI comprising:
a first user input field configured to receive a first user input identifying a budget administrator to log in to a budget approval workflow configuration system (BAWCS);
in response to a successful log in to the BAWCS, obtaining master data associated with the budget administrator; and
updating the GUI output by the UI, the GUI further comprising:
a presentation of each budget associated with the budget administrator;
a second user input field configured to receive a second user input identifying a first reviewer to perform first reviewer responsibilities;
a third user input field configured to receive a third user input identifying a workflow action based on a first reviewer approval or rejection of a budget;
a fourth user input field configured to receive a fourth user input identifying a workflow location for the budget based on the first reviewer approval or rejection of the budget; and
a fifth user input field configured to receive a fifth user input identifying email addresses to provide email notification for each operation within a budget approval process.

14. The method of claim 13, wherein the GUI output by the UI further comprising:
a sixth user input field configured to receive a sixth user input identifying a sequential reviewer after the first reviewer, wherein the budget administrator inputs up to N reviewers, where N is a non-zero positive integer, that sequentially receive and review the budget after each sequential budget approval beginning with the first reviewer approval.

15. The method of claim 13, wherein the GUI output by the UI further comprising:
a seventh user input field configured to receive a seventh user input identifying an effective start date for assigned reviewer responsibilities.

16. A non-transitory computer readable medium including instructions executable by a controller to perform operations comprising:
causing a graphical user interface (GUI) to be output by a user interface (UI), the GUI comprising:
a first user input field configured to receive a first user input identifying a budget administrator to log in to a budget approval workflow configuration system (BAWCS);
in response to a successful log in to the BAWCS, obtaining master data associated with the budget administrator; and
updating the GUI output by the UI, the GUI further comprising:
a presentation of each budget associated with the budget administrator;
a second user input field configured to receive a second user input identifying a first reviewer to perform first reviewer responsibilities;
a third user input field configured to receive a third user input identifying a workflow action based on a first reviewer approval or rejection of a budget;
a fourth user input field configured to receive a fourth user input identifying a workflow location for the budget based on the first reviewer approval or rejection of the budget; and
a fifth user input field configured to receive a fifth user input identifying email addresses to provide email notification for each operation within a budget approval process.

17. The non-transitory computer readable medium of claim 16, wherein the GUI output by the UI further comprising:
a sixth user input field configured to receive a sixth user input identifying a sequential reviewer after the first reviewer, wherein the budget administrator inputs up to N reviewers, where N is a non-zero positive integer, that sequentially receive and review the budget after each sequential budget approval beginning with the first reviewer approval.

18. The non-transitory computer readable medium of claim 17, wherein the GUI output by the UI further comprising:
a seventh user input field configured to receive a seventh user input identifying an effective start date for assigned reviewer responsibilities.

19. The non-transitory computer readable medium of claim 18, wherein the instructions executable by a controller further performs operations comprising:
activating an approval workflow based on the effective start date.

20. The non-transitory computer readable medium of claim 19, wherein instructions executable by a controller further performs operations comprising:
retrieving active approval flow for each budget type; and
obtaining execution operations in the approval workflow to the budget.
